(19) United States
(12) Patent Application Publication
(10) Pub. No.: US 2007/0084570 A1
(43) Pub. Date: Apr. 19, 2007

(54) Lift device of a blind

(76) Inventor: Gwo-Tsair Lin, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/251,778

(22) Filed: Oct. 18, 2005

(51) Int. Cl. E06B 9/56

(52) U.S. Cl. 160/321

(57) ABSTRACT

A blind lift device includes a fixed support, a rotating member next to the fixed support, a bead chain passed over the rotating member, a first planetary gear train between the fixed support and the rotating member, a brake member joined to the rotating member, a cap, a second planetary gear set between the brake member and the cap, and a main shaft; the second planetary gear set has a connecting shaft portion projecting through the cap, and planetary gears engaged with the brake member and an internal gear of the cap; the main shaft is joined to the connecting shaft portion and a covering member of a blind; thus, the rotational velocity ratio of the main shaft to the rotating member can be changed to suit different covering members by means of selecting and using suitable planetary gear trains according to the dimensions and weights of the covering members.

### BACKGROUND OF THE INVENTION

1. Field of the Invention

The present invention relates to a lift device of a blind, more particularly one, which can be adapted so as to suit blind covering members with different dimensions and weights by means of replacing only a few parts thereof.

2. Brief Description of the Prior Art

Windows of a room allow daylight and fresh air to enter the room. However, people in a room are afraid of being seen through the windows. Therefore, windows are usually equipped with blinds so that they can be covered with the blinds if necessary. Various kinds of blinds are available, e.g. roller blinds, roll-up blinds, and Venetian blinds.

Referring to FIG. 1, a currently existing roller blind includes an elongate support 1, a fixed support member 11 secured to a tail end of the elongate support 1, a rotating member 13 supported on the fixed support member 11, a bead chain 12 passed over the rotating member 13, and a main shaft 14 joined to the rotating member 13, and a blind cloth (not shown) joined to the main shaft 14. Therefore, the blind cloth can be lifted and lowered by means of pulling the bead chain 12 to rotate the rotating member 13 and the main shaft 14.

However, it will be difficult to lift the blind cloth if the blind cloth is very large and heavy.

### SUMMARY OF THE INVENTION

It is a main object of the invention to provide an improvement on a lift device of a blind to overcome the above-mentioned problem. The lift device of the present invention includes a fixed support, a rotating member next to the fixed support, a bead chain passed over the rotating member, a first planetary gear train between the fixed support and the rotating member, a brake member joined to the rotating member, a cap, a second planetary gear set between the brake member and the cap, and a main shaft. The second planetary gear set has a connecting shaft portion projecting outwards through a hole of the cap, and several planetary gears engaged with the brake member and an internal gear of the cap. The main shaft is joined to the connecting shaft portion and a covering member of a blind. Thus, the rotational velocity ratio of the main shaft to the rotating member can be easily changed to suit different covering members by means of selecting and using suitable planetary gear trains according to the dimensions and weights of the covering members.

### BRIEF DESCRIPTION OF THE DRAWINGS

The present invention will be better understood by referring to the accompanying drawings, wherein:

FIG. 1 is an exploded perspective view of the conventional lift device of a blind,

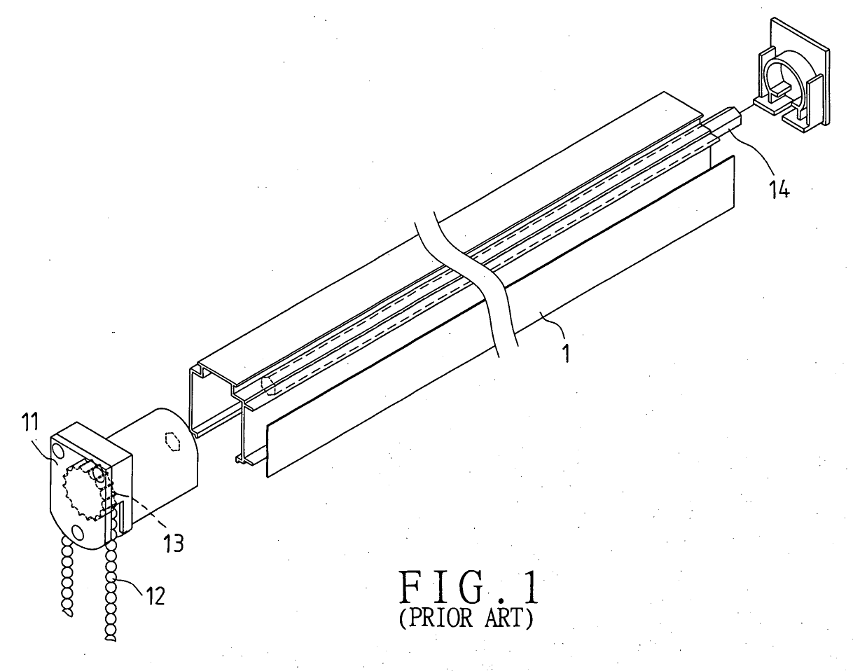

FIG. 2 is an exploded perspective view of the first preferred embodiment of a lift device of a blind,

FIG. 3 is a sectional view of the first preferred embodiment,

FIG. 4 is an exploded perspective view of the second embodiment,

FIG. 5 is a sectional view of the second preferred embodiment,

FIG. 6 is an exploded perspective view of the third preferred embodiment, and

FIG. 7 is a sectional view of the third preferred embodiment.

### DETAILED DESCRIPTION OF THE PREFERRED EMBODIMENTS

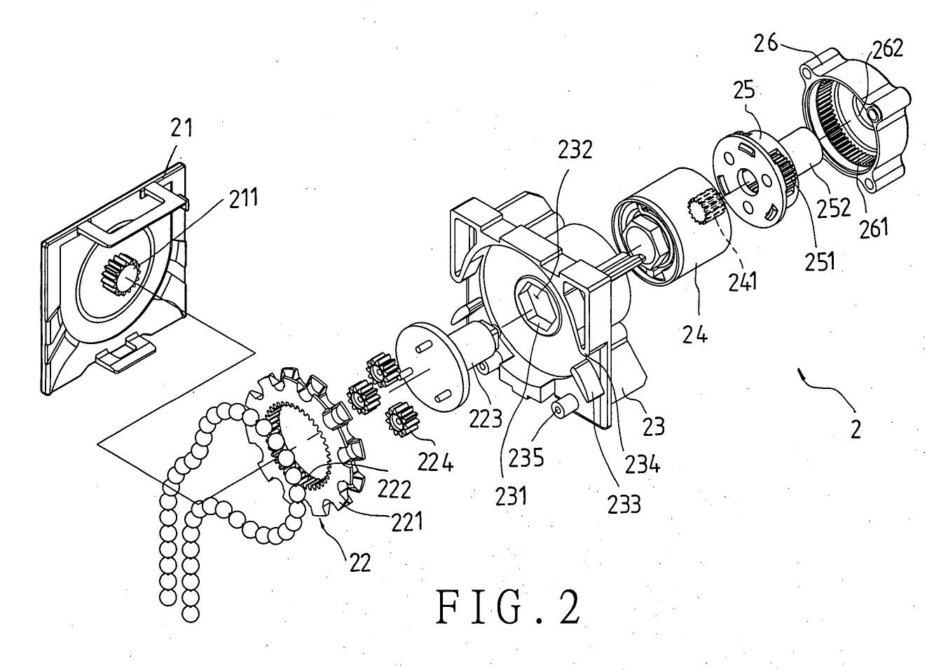

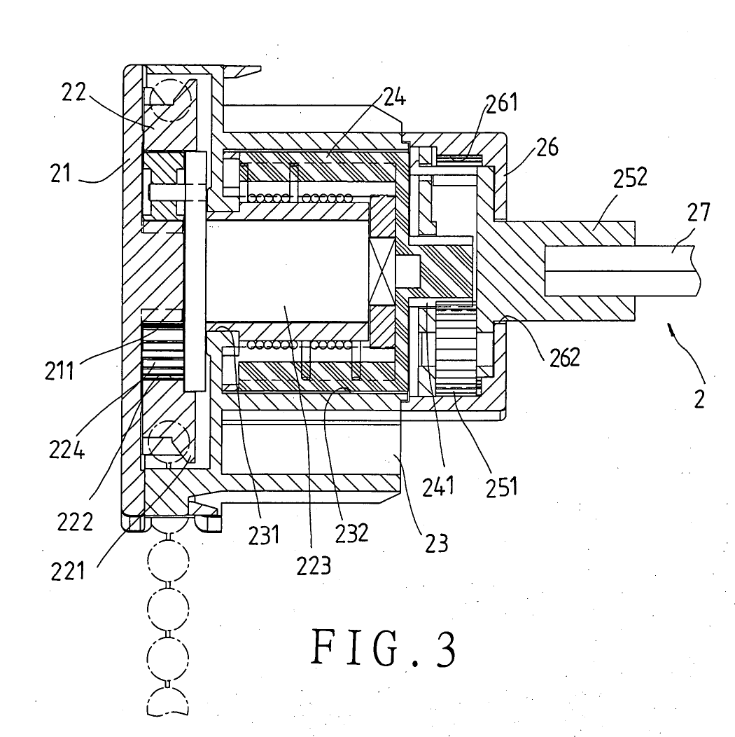

Referring to FIGS. 2 and 3, a preferred embodiment 2 of a lift device of a blind in the present invention includes:

a fixed support 21; the fixed support 21 is securely joined to a tail end of an elongate main support member of a blind; the fixed support 21 has a gear 211 on an inner side thereof;

a rotating member 22 positioned next to the inner side of the fixed support 21; the rotating member 22 includes a rotating disk 221, a rotating shaft 223, and several planetary gears 224; the rotating disk 221 is next to the fixed support 21, and it has an internal gear 222; the rotating shaft 223 is connected to the planetary gears 224 while the planetary gears 224 are engaged with the internal gear 222 as well as the gear 211 of the fixed support 21 such that a planetary gear train is formed;

a pulling member passed over the rotating member 22; the pulling member can be a bead chain or a cord;

a connecting and supporting member 23 securely joined to the fixed support 21; the connecting and supporting member 23 has a hole 231 on one side; the rotating shaft 223 of the rotating member 22 is passed through the hole 231; the connecting and supporting member 23 has a holding hole 232 on the other side, two sloping guide parts 233 on two lateral sides of a lower portion thereof, a guiding protrusion 234 right above each of the sloping guide parts 233, and a roller 235 under each of the sloping guide parts 233 such that there are passages between the guiding protrusions 234 and the sloping guide parts 233, and there are passages between the sloping guide parts 233 and the rollers 235 as well; two ends of the pulling member, which are used for lifting and lowering the blind respectively, are passed through the passages between the guiding protrusions 234 and the sloping guide parts 233 as well as the passages between the sloping guide parts 233 and the rollers 235;

a brake member 24; the brake member 24 is held in the holding hole 232 of the connecting and supporting member 23; the rotating shaft 223 is inserted in one end of the brake member 24 to engage the brake member 24; the brake member 24 has a gear 241 projecting from the other end thereof;

a planetary gear set 25 including several planetary gears 251, and a connecting shaft portion 252; the planetary gears 251 engage the gear 241 of the brake member 24;

a cap 26 having an internal gear 261, and a through hole 262; the cap 26 is positioned over the planetary gear set 25, and securely connected to the connecting and supporting member 23 with the connecting shaft portion 252 of the planetary gear set 25 projecting outwards through the through hole 262 thereof, and with the internal gear 261 thereof engaging the planetary gear set 25 such that a second planetary gear train is formed; and

a main shaft 27; the main shaft 27 is inserted in and joined to the connecting shaft portion 252 of the planetary gear set 25 at one end, and it is joined to a covering member (not shown) of the blind.

When the user pulls the pulling member such as a bead chain to make the rotating member 22 rotate, the rotating member 22 will cause movement of the planetary gear train between the rotating disk 221 and the fixed support 21, and the rotational velocity ratio of the rotating shaft 223 to the rotating disk 221 will be 1:2. When the rotating shaft 223 of the rotating member 22 is rotated, it will cause movement of the brake member 24 at the same speed, which the rotating shaft 223 is inserted in and engaged with, and in turn the gear 241 of the brake member 24 will cause movement of the second planetary gear train, and the rotational velocity ratio of the gear 241 to the main shaft 27 will be 3.5:1. Therefore, the rotational velocity ratio of the main shaft 27 to the rotating disk 221 is 1:7. And, it will take more time, but save the user labor when the user is lifting the blind with the lift device. In other words, even if the lift device is used on a very large and heavy blind, there won't be problem in lifting the blind with the lift device.

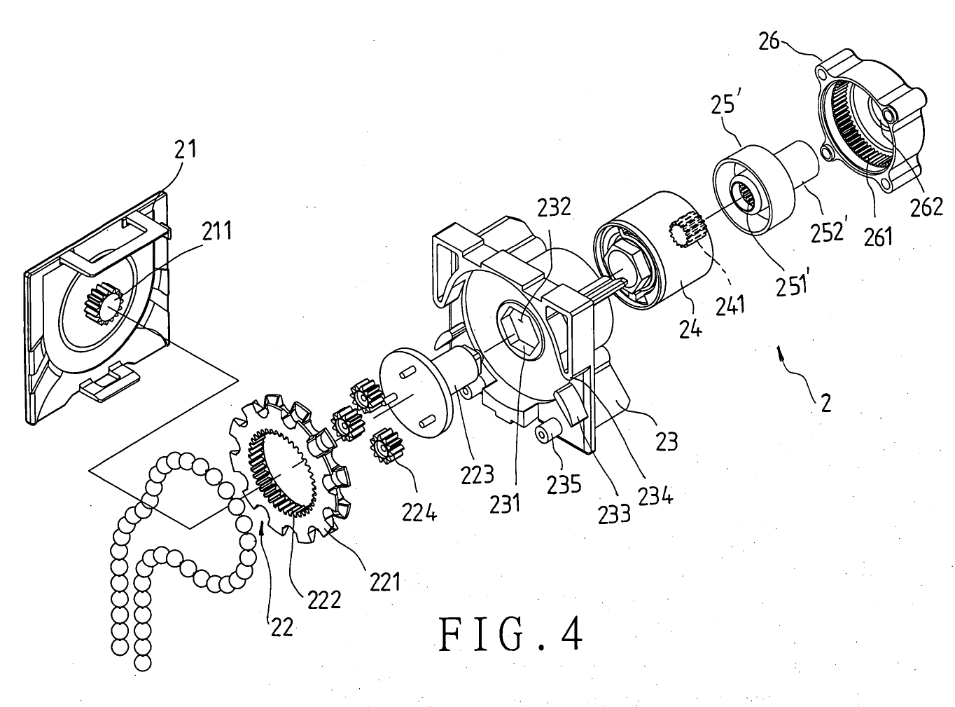

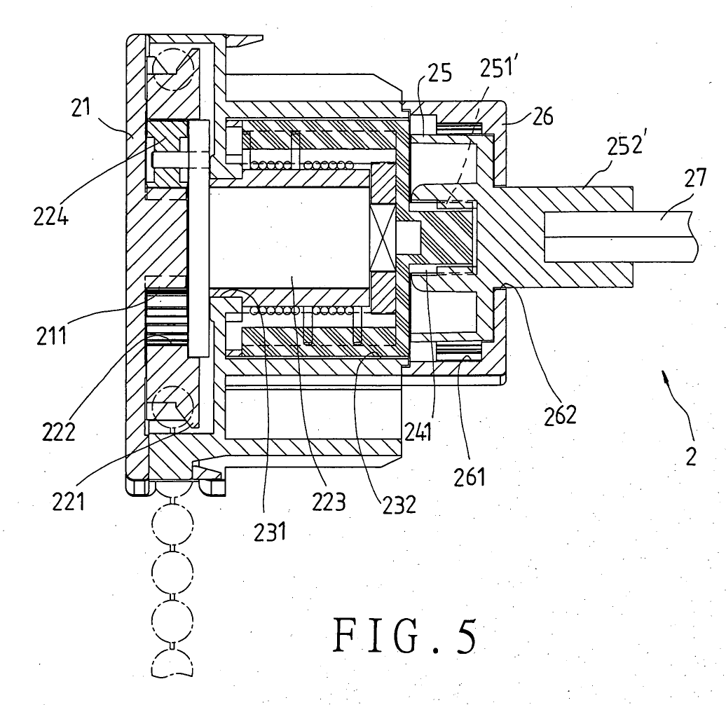

The above lift device can be adapted so as to suit blind covering members with different dimensions and weights by means of replacing only a few parts thereof. Referring to FIGS. 4 and 5, a second preferred embodiment of a lift device of a blind in the present invention includes:

a fixed support 21; the fixed support 21 is securely joined to a tail end of an elongate main support member of a blind; the fixed support 21 has a gear 211 on an inner side thereof;

a rotating member 22 positioned next to the inner side of the fixed support 21; the rotating member 22 includes a rotating disk 221, a rotating shaft 223, and several planetary gears 224; the rotating disk 221 is next to the fixed support 21, and it has an internal gear 222; the rotating shaft 223 is connected to the planetary gears 224 while the planetary gears 224 are engaged with the internal gear 222 as well as the gear 211 of the fixed support 21 such that a planetary gear train is formed;

a pulling member passed over the rotating member 22; the pulling member can be a bead chain or a cord;

a connecting and supporting member 23 securely joined to the fixed support 21; the connecting and supporting member 23 has a hole 231 on one side, through which the rotating shaft 223 of the rotating member 22 is passed; the connecting and supporting member 23 has a holding hole 232 on the other side, two sloping guide parts 233 on two lateral sides of a lower portion thereof, a guiding protrusion 234 right above each of the sloping guide parts 233, and a roller 235 under each of the sloping guide parts 233 such that there are passages between the guiding protrusions 234 and the sloping guide parts 233, and there are passages between the sloping guide parts 233 and the rollers 235 as well; two ends of the pulling member are passed through the passages between the guiding protrusions 234 and the sloping guide parts 233 as well as the passages between the sloping guide parts 233 and the rollers 235;

a brake member 24; the brake member 24 is held in the holding hole 232 of the connecting and supporting member 23; the rotating shaft 223 is inserted in one of the brake member 24 so as to engage the brake member 24; the brake member 24 has a gear 241 projecting from the other end;

a shaft sleeve 25′; the shaft sleeve 25′ has a sleek outer surface, an internal gear 251′ in one end, and a connecting shaft portion 252′ at the other end thereof; the internal gear 251′ engages the gear 241 of the brake member 24;

a cap 26 having a through hole 262; the cap 26 is securely joined to the connecting and supporting member 23 with the connecting shaft portion 252′ of the shaft sleeve 25′ projecting outwards through the through hole 262 thereof; and

a main shaft 27; the main shaft 27 is inserted in and joined to the connecting shaft portion 252′ of the shaft sleeve 25′ at one end, and it is joined to a blind covering member.

Therefore, when the user pulls the pulling member (a bead chain) to make the rotating member 22 rotate, the rotating member 22 will cause movement of the planetary gear train between the rotating disk 221 and the fixed support 21, and the rotational velocity ratio of the rotating shaft 223 to the rotating disk 221 will be 1:2. When the rotating shaft 223 of the rotating member 22 is rotated, it will cause movement of the brake member 24 at the same speed, and in turn the gear 241 of the brake member 24 will cause movement of the shaft sleeve 25′ engaged with the brake member 24 as well as the main shaft 27. Therefore, the rotational velocity ratio of the main shaft 27 to the rotating disk 221 is 1:2, and the present lift device is more suitable for use on a blind having much smaller dimensions and weight than the first preferred embodiment. Consequently, the user can lift the blind more quickly, and the present lift device will also save the user labor.

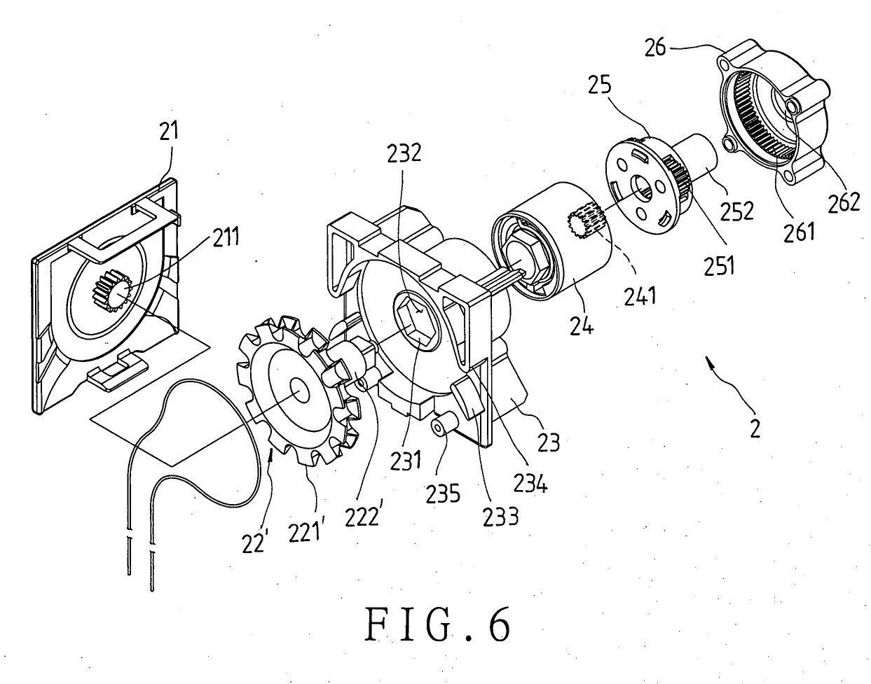

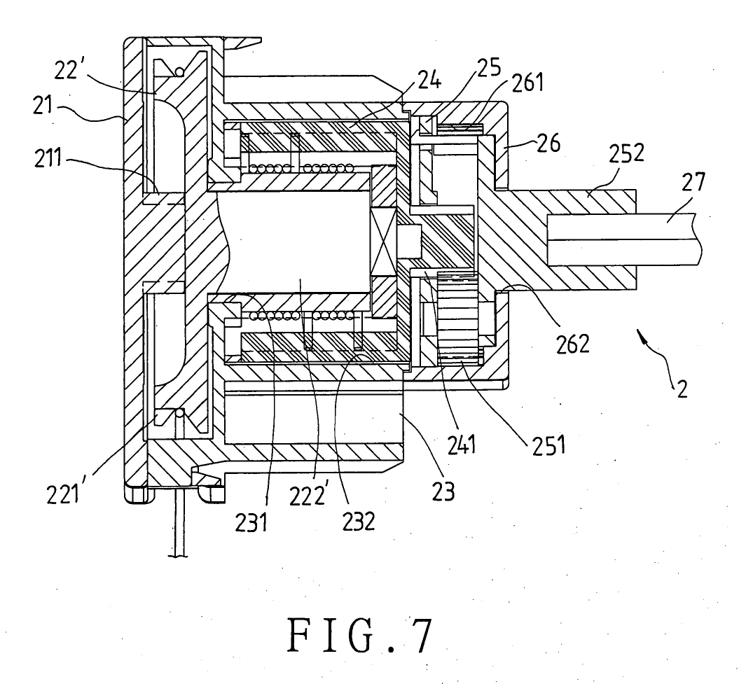

Referring to FIGS. 6 and 7, a third preferred embodiment of a lift device of a blind in the present invention includes:

a fixed support 21; the fixed support 21 is securely joined to a tail end of an elongate main support member of a blind; the fixed support 21 has a gear 211 on an inner side thereof;

a rotating member 22′ positioned next to the inner side of the fixed support 21; the rotating member 22′ includes a rotating disk 221′, and a rotating shaft 222′ securely joined to the rotating disk 221′;

a pulling member passed over the rotating disk 221′ of the rotating member 22′; the pulling member can be a bead chain or a cord;

a connecting and supporting member 23 securely joined to the fixed support 21; the connecting and supporting member 23 has a hole 231 on one side; the rotating shaft 222′ of the rotating member 22 is passed through the hole 231; the connecting and supporting member 23 has a holding hole 232 on the other side, two sloping guide parts 233 on two lateral sides of a lower portion thereof, a guiding protrusion 234 right above each of the sloping guide parts 233, and a roller 235 under each of the sloping guide parts 233 such that there are passages between the guiding protrusions 234 and the sloping guide parts 233, and there are passages between the sloping guide parts 233 and the rollers 235 as well; two ends of the pulling member are passed through the passages between the guiding protrusions 234 and the sloping guide parts 233 as well as the passages between the sloping guide parts 233 and the rollers 235;

a brake member 24; the brake member 24 is held in the holding hole 232 of the connecting and supporting member 23; the rotating shaft 222′ is inserted in one end of the brake member 24 so as to engage the brake member 24; the brake member 24 has a gear 241 projecting from the other end;

a planetary gear set 25 including several planetary gears 251, and a connecting shaft portion 252; the planetary gears 251 engage the gear 241 of the brake member 24;

a cap 26 having an internal gear 261, and a through hole 262; the cap 26 is positioned over the planetary gear set 25, and securely connected to the connecting and supporting member 23 with the connecting shaft portion 252 of the planetary gear set 25 projecting outwards through the through hole 262 thereof, and with the internal gear 261 thereof engaging the planetary gear set 25 such that a second planetary gear train is formed; and

a main shaft 27; the main shaft 27 is inserted in and joined to the connecting shaft portion 252 of the planetary gear set 25 at one end, and it is joined to a blind covering member.

Therefore, when the user pulls the pulling member (a bead chain) to make the rotating member 22 rotate, the rotating shaft 223 of the rotating member 22 will cause movement of the brake member 24 at the same speed, and in turn the gear 241 of the brake member 24 will cause movement of the second planetary gear train, and the rotational velocity ratio of the gear 241 to the main shaft 27 will be 3.5:1. Therefore, the rotational velocity ratio of the main shaft 27 to the rotating disk 221 is 1:3.5, and the present lift device is suitable for use on a blind with medium size and weight. And, the blind still can be lifted at a relatively high speed, and the present invention will also save the user labor.

From the above description, it can be easily seen that the present invention has the following advantages:

1. The lift devices of the present invention can be adapted so as to suit blind covering members with different dimensions and weights by means of replacing a few parts thereof, thus saving the users labor and time.

2. The manufacturers will have lower inventory and warehouse management cost, and the lift devices of the present invention are competitive because they are allowed to manufacture a lift device with a suitable velocity ratio according to the dimensions and weight of a blind without having to add a lot of new parts.

What is claimed is:

1. A lift device of a blind, comprising
(a) a fixed support securely joined to a tail end of an elongate main support member of a blind; the fixed support having a gear on an inner side thereof;
(b) a rotating member positioned next to the inner side of the fixed support; the rotating member including
a rotating disk next to the fixed support; the rotating disk having an internal gear;
a plurality of planetary gears engaged with the internal gear of the rotating disk as well as the gear of the fixed support; and
a rotating shaft connected to the planetary gears;
(c) a bead chain passed over the rotating member;
(d) a connecting and supporting member securely joined to the fixed support; the connecting and supporting member having a first hole on one side, through which the rotating shaft of the rotating member is passed; the connecting and supporting member having a second hole on other side;
(e) a brake member held in the second hole of the connecting and supporting member; the rotating shaft of the rotating member being inserted in one end of the brake member to engage the brake member; the brake member having a gear projecting from other end thereof;
(f) a second planetary gear set; the second planetary gear set having a connecting shaft portion; the second planetary gear set having a plurality of planetary gears engaged with the gear of the brake member;
(g) a cap having a through hole; the cap being positioned over the second planetary gear set and secured to the connecting and supporting member with the connecting shaft portion projecting outwards through the through hole thereof; the cap having an internal gear engaging the second planetary gear set; and
(h) a main shaft joined to a covering member of the blind; the main shaft being inserted in and joined to the connecting shaft portion of the second planetary gear set at one end.

2. The blind lift device as claimed in claim 1, wherein the connecting and supporting member has two sloping guide parts on two lateral sides of a lower portion thereof, a guiding protrusion right above each of the sloping guide parts, and a roller under each of the sloping guide parts such that there are passages between the guiding protrusions and the sloping guide parts, and there are passages between the sloping guide parts and the rollers as well; two ends of the bead chain are passed through the passages between the guiding protrusions and the sloping guide parts as well as the passages between the sloping guide parts and the rollers.

3. A lift device of a blind, comprising
(a) a fixed support securely joined to a tail end of an elongate main support member of a blind; the fixed support having a gear on an inner side thereof;
(b) a rotating member positioned next to the inner side of the fixed support; the rotating member including
a rotating disk next to the fixed support; the rotating disk having an internal gear;
a plurality of planetary gears engaged with the internal gear of the rotating disk as well as the gear of the fixed support; and
a rotating shaft connected to the planetary gears;
(c) a bead chain passed over the rotating member;
(d) a connecting and supporting member securely joined to the fixed support; the connecting and supporting member having a first hole on one side, through which the rotating shaft of the rotating member is passed; the connecting and supporting member having a second hole on other side;
(e) a brake member held in the second hole of the connecting and supporting member; the rotating shaft of the rotating member being inserted in one end of the brake member to engage the brake member; the brake member having a gear projecting from other end thereof;
(f) a shaft sleeve; the shaft sleeve having an internal gear in one end thereof, which engages the gear of the brake member; the shaft sleeve having a connecting shaft portion at other end;
(g) a cap having a through hole; the cap being positioned over the shaft sleeve and secured to the connecting and supporting member with the connecting shaft portion of the shaft sleeve projecting outwards through the through hole thereof; and
(h) a main shaft joined to a blind covering member; the main shaft being inserted in and joined to the connecting shaft portion of the shaft sleeve at one end.

4. The blind lift device as claimed in claim 3, wherein the connecting and supporting member has two sloping guide parts on two lateral sides of a lower portion thereof, a guiding protrusion right above each of the sloping guide parts, and a roller under each of the sloping guide parts such that there are passages between the guiding protrusions and the sloping guide parts, and there are passages between the sloping guide parts and the rollers as well; two ends of the bead chain are passed through the passages between the guiding protrusions and the sloping guide parts as well as the passages between the sloping guide parts and the rollers.

5. A lift device of a blind, comprising
(a) a fixed support securely joined to a tail end of an elongate main support member of a blind; the fixed support having a gear on an inner side thereof;
(b) a rotating member positioned next to the inner side of the fixed support; the rotating member including a rotating disk portion, and a rotating shaft securely joined to the rotating shaft;
(c) a bead chain passed over the rotating member;
(d) a connecting and supporting member securely joined to the fixed support; the connecting and supporting member having a first hole on one side, through which the rotating shaft of the rotating member is passed; the connecting and supporting member having a second hole on other side;
(e) a brake member held in the second hole of the connecting and supporting member; the rotating shaft of the rotating member being inserted in one end of the brake member to engage the brake member; the brake member having a gear projecting from other end thereof;
(f) a second planetary gear set; the second planetary gear set having a connecting shaft portion; the second planetary gear set having a plurality of planetary gears engaged with the gear of the brake member;
(g) a cap having a through hole; the cap being positioned over the second planetary gear set and secured to the connecting and supporting member with the connecting shaft portion projecting outwards through the through hole thereof; the cap having an internal gear engaging the second planetary gear set; and
(h) a main shaft joined to a blind covering member; the main shaft being inserted in and joined to the connecting shaft portion of the second planetary gear set at one end.

6. The blind lift device as claimed in claim 5, wherein the connecting and supporting member has two sloping guide parts on two lateral sides of a lower portion thereof, a guiding protrusion right above each of the sloping guide parts, and a roller under each of the sloping guide parts such that there are passages between the guiding protrusions and the sloping guide parts, and there are passages between the sloping guide parts and the rollers as well; two ends of the bead chain are passed through the passages between the guiding protrusions and the sloping guide parts as well as the passages between the sloping guide parts and the rollers.
